(19) United States
(12) Patent Application Publication
(10) Pub. No.: US 2017/0154062 A1
(43) Pub. Date: Jun. 1, 2017

(54) Data evaluation device using similarity, method therefor, and computer-readable recording medium having the method recorded thereon

(71) Applicant: SUNGSHIN WOMEN'S UNIVERSITY INDUSTRY-ACADEMIC COOPERATION FOUNDATION, Seoul (KR)

(72) Inventor: Jong Soo PARK, Seoul (KR)

(73) Assignee: SUNGSHIN WOMEN'S UNIVERSITY INDUSTRY-ACADEMIC COOPERATION FOUNDATION, Seoul (KR)

(21) Appl. No.: 14/757,507

(22) Filed: Dec. 23, 2015

(30) Foreign Application Priority Data
Nov. 26, 2015 (KR) 10-2015-0166556

(51) Int. Cl. G06F 17/30

(52) U.S. Cl. CPC G06F 17/30345; G06F 17/30336; G06F 17/30572

(57) ABSTRACT

Disclosed herein is a data evaluation device using similarity for searching a plurality of documents for a document similar or substantially identical to a given document, a method therefor, and a computer-readable recording medium with the method recorded thereon. The data evaluation device using similarity includes an input unit receiving first and second records, a record set generating unit arraying the first and second records in alphabetical order and giving one token to each arrayed word to generate corresponding first and second record sets, and a similarity verifying unit determining that the first and second records are not similar when a position at which a comparison token in the first record set, which is allocated to a word identical to a median value token disposed at a position corresponding to a median value in the second record set, is in a preset range.

### CROSS-REFERENCE TO RELATED APPLICATION

This application claims the benefit of Korean Patent Application No. 10-2015-0166556, filed on Nov. 26, 2015 in the Korean Intellectual Property Office, the disclosures of which are incorporated herein by reference.

### BACKGROUND OF THE INVENTION

1. Field of the Invention

The present invention relates generally to a data evaluation device using similarity, a method therefor, and a computer-readable recording medium with the method recorded thereon. More particularly, the present invention relates to a data evaluation device using similarity for searching a plurality of documents for a document similar or substantially identical to a given document, a method therefor, and a computer-readable recording medium with the method recorded thereon.

2. Description of the Related Art

As is well known to those skilled in the art, since a similarity join, in which a plurality of documents is searched for a document similar or nearly identical to a given document, may be applied to data cleaning or duplicate detection, it is one of important operations in a database or data mining field.

A technique that is most widely employed among methods for finding a similarity between two documents is a generation-verification structure, and this structure includes a step for removing multiple non-similar pairs to generate the small number of similarity join candidate pairs and a step for calculating an actual similarity of each similarity join candidate pair to output a result when the actual similarity is equal to or greater than a threshold value.

However, in the above-described method for searching a similarity, many algorithms are proposed which optimize a step for generating similarity join candidate pairs by using a filter such as prefix filtering as disclosed in Korean Patent No. 10-1524375. However, since an application of a filter to generation of a similarity join candidate pair increases a cost, it is difficult to add a filter for improving performance.

### SUMMARY OF THE INVENTION

Accordingly, the present invention has been made keeping in mind the above problems occurring in the prior art, and an object of the present invention is to provide a data evaluation device using similarity, which is capable of rapidly obtaining a similarity determination result by using a median value of one record as a filter for checking whether the number of tokens, which are common to other records, in similar record candidate pairs is proper, a method therefor, and a computer-readable recording medium with the method recorded thereon.

In order to accomplish the above object, the present invention provides a data evaluation device using similarity including: an input unit receiving first and second records; a record set generating unit arraying words in the first and second records in alphabetical order and giving one token to each arrayed word to generate corresponding first and second record sets; and a similarity verifying unit determining that the first and second records are not similar when a position at which a comparison token in the first record set, which is allocated to a word identical to a median value token disposed at a position corresponding to a median value in the second record set, is in a preset range.

The alphabetical order may be ASCII code order.

The data evaluation device using similarity may further include a similarity calculating unit calculating a similarity of the first and second records as a Jaccard similarity defined as

$$\frac{\vert first record set ⋂ second record set \vert}{\vert first record set ⋃ second record set \vert}$$

and an overlap similarity defined as |first record set∩second record set|. A Jaccard minimum value, which is a minimum value for determining the first and second records to be similar according to the Jaccard similarity may have a relation of

$$overlap min value = \frac{Jaccard min value}{Jaccard min value + 1} \times ( \vert first record set \vert + \vert second record set \vert )$$

with an overlap minimum value, which is a minimum value for determining the first and second records to be similar according to the overlap similarity.

The similarity verifying unit may sequentially allocate indexes to tokens in the first record set and tokens in the second record set, and determines that the first and second records are not similar when an index of the comparison token is smaller than

overlap min value−|first record set∩second record set|−max index of second record set+index of median value token+min index of first record set−1.

The similarity verifying unit may sequentially allocate indexes to tokens in the first record set and tokens in the second record set, and determines that the first and second records are not similar when an index of the comparison token exceeds

|first record set∩second record set|−overlap min value+index of median value token−min index of second record set+max index of first record set+1.

In order to accomplish the above object, the present invention also provides a data evaluation method using similarity including: receiving first and second records; arraying the first and second records in alphabetical order and giving one token to each arrayed word to generate corresponding first and second record sets; and determining that the first and second records are not similar when a position at which a comparison token in the first record set, which is allocated to a word identical to a median value token disposed at a position corresponding to a median value in the second record set, is in a preset range.

The alphabetical order may be ASCII code order.

The data evaluation method using similarity may further include calculating a similarity of the first and second records as a Jaccard similarity defined as

$$\frac{\vert first record set ⋂ second record set \vert}{\vert first record set ⋃ second record set \vert}$$

and an overlap similarity defined as |first record set∩second record set|. In the determining, a Jaccard minimum value, which is a minimum value for determining the first and second records to be similar according to the Jaccard similarity may have a relation of

$$overlap min value = \frac{Jaccard min value}{Jaccard min value + 1} \times ( \vert first record set \vert + \vert second record set \vert )$$

with an overlap minimum value, which is a minimum value for determining the first and second records to be similar according to the overlap similarity.

The determining may include sequentially allocating indexes to tokens in the first record set and tokens in the second record set, and determines that the first and second records are not similar when an index of the comparison token is smaller than

overlap min value−|first record set∩second record set|−max index of second record set+index of median value token+min index of first record set−1.

The determining may include sequentially allocating indexes to tokens in the first record set and tokens in the second record set, and determines that the first and second records are not similar when an index of the comparison token exceeds

|first record set∩second record set|−overlap min value+index of median value token−index of second record set+max index of first record set+1.

In order to accomplish the above object, the present invention still also provides a computer-readable medium with the method of the foregoing recorded thereon.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a view illustrating a data evaluation device using similarity according to an embodiment of the present invention;

FIG. 2 illustrates a token position and an index value according to an array of first and second record sets corresponding to similarity determination candidate pairs;

FIG. 3 is a view illustrating a data evaluation method using similarity according to an embodiment of the present invention;

FIG. 4A is a graph representing, according to a threshold value, execution times during which a method of the present invention and a comparison target method are executed with respect to records obtained by collecting emails of Eron company;

FIG. 4B is a graph representing, according to a threshold value, execution times during which a method of the present invention and a comparison target method are executed with respect to bench macro documents included in a Trec data set;

FIG. 4C is a graph representing, according to a threshold value, execution times for which a method of the present invention and a comparison target method are executed with respect to a reference list record, which is obtainable from a DBLP web site; and

FIG. 5 is a graph illustrating relative performance gains obtained by applying a data evaluation method using similarity to three data sets used in FIGS. 4A to 4C.

### DESCRIPTION OF THE PREFERRED EMBODIMENTS

Hereinafter, embodiments of the present invention will be described in detail with reference to the attached drawings.

Reference now should be made to the drawings, in which the same reference numerals are used throughout the different drawings to designate the same or similar components.

Detailed example embodiments are disclosed herein. However, specific structural and functional details disclosed herein are merely representative for purposes of describing example embodiments. Example embodiments may, however, be embodied in many alternate forms and should not be construed as limited to only the embodiments set forth herein. Accordingly, since example embodiments are capable of various modifications and alternative forms, it should be understood that example embodiments are to cover all modifications, equivalents, and alternatives falling within the scope of example embodiments.

Furthermore, the terminology used herein should be understood as follows.

The terms “first”, “second”, etc. may be used herein to distinguish one element from another element, not to be limited by the terms. For example, a first element could be termed a second element, and, similarly, a second element could be termed a first element, without departing from the scope of example embodiments.

It will be understood that when an element is referred to as being “connected” or “coupled” to another element, it may be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion, e.g., “between” versus “directly between”, “adjacent” versus “directly adjacent”, etc.

It will be further understood that the singular form of a word includes the plural form of the word unless they are clearly different from context. The terms “comprises”, “comprising”, “includes”, and/or “including”, when used herein, specify the presence of stated features, integers, steps, operations, elements, components or combinations thereof, but do not preclude the presence or addition of one or more other features, integers, steps, operations, elements, components, or combinations thereof.

The steps described herein can be performed in any suitable order unless otherwise indicated herein or otherwise clearly contradicted by context. In other words, steps can be performed identically to the described order, can be performed at the substantially same time, or they can be performed sometimes in reverse order according to the corresponding functions.

Unless otherwise defined, all terms used herein have the same meaning as commonly understood by one of ordinary skill in the art to which example embodiments belong. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

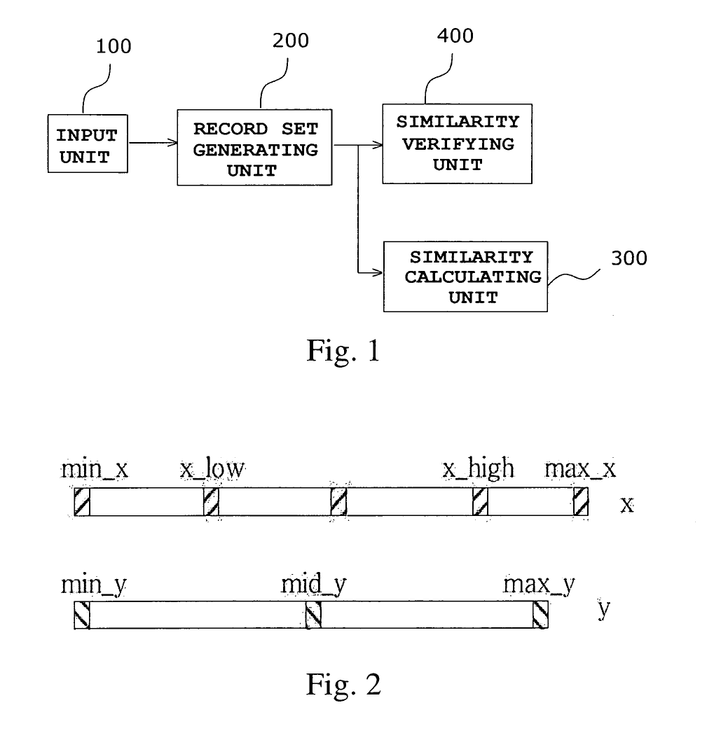

FIG. 1 illustrates a data evaluation device using similarity according to an embodiment of the present invention, and the data evaluation device using similarity may include an input unit 100, a record set generating unit 200, a similarity calculating unit 300, and a similarity verifying unit 400.

The input unit 100 receives first and second records and outputs the input first and second records to the record set generating unit 200. Here, the first and second records may be a reference list record that is obtainable at a DBLP website (http://dblp.uni-trier.de/xml), and further, may be a record in which bench macro documents included in a Trec data set (http://trec.nist.gov/data/t9_filtering.html) and emails of Eron company (http://www.cs.cmu.edu/˜enron/) are collected. In other words, documents in which words may be distinguished with punctuations and blanks are all available.

In addition, the record set generating unit 200 may receive the first and second records from the input unit 100, arrange words in the input first and second records in alphabetical order, give one token to each arranged word to generate corresponding first and second record sets, and may output the generated first and second record sets to the similarity calculating unit 300 and the similarity verifying unit 400.

Here, the record set generating unit 200 parses documents or emails, which are the first and second records, into a plurality of words and converts them into a record set, which is a multi-set of tokens. Furthermore, the record set generating unit 200 may use blanks and a plurality of punctuation as distinguishing characters in order to transform a character sequence of the first and second records into tokens, and gives tokens after the distinguished words are arranged in alphabetical order, e.g., preferably in order of ASCII code. In addition, tokens may appear several times in each of the first and second records, and the record set generating unit 200 treats identical tokens continuously appearing as new tokens and assigns different token numbers. At this point, the tokens of the first and second records may be stored in order of token number.

On the other hand, the similarity calculating unit 300 may calculate similarity of the first and second records with a Jaccard similarity and an overlap similarity, and may output the calculated overlap similarity to the similarity verifying unit 400.

Firstly, the Jaccard similarity may be calculated by the following Equation (1) when the first record (hereinafter ‘x’) includes |x| tokens and the second record (hereinafter ‘y’) includes |y| tokens.

$$J ( x , y ) = \frac{\vert x ⋂ y \vert}{\vert x ⋃ y \vert} \qquad ( 1 )$$

where J(x, y) denotes a Jaccard similarity function, which becomes a value obtained by dividing the number of intersections of the first and second record sets by the number of unions of the first and second record sets. In other words, the Jaccard similarity may be calculated as a value in the range of 0 to 1.

In addition, the overlap similarity may be calculated by the following Equation (2).

O(x,y)=|x∩y| (2)

where O(x, y) denotes an overlap similarity function, and becomes a value that is the number of intersections of the first and second record sets.

On the other hand, a threshold value t, which is a lowest limit value of the Jaccard similarity for the two records to be similar, may be determined in the range of 0.6 or greater and smaller than 1, and the number α of tokens, which are common to the two records and necessary for the two records to be similar, is calculated as the following Equation (3).

$$O ( x , y ) \geq α = \frac{t}{1 + t} \cdot ( \vert x \vert + \vert y \vert ) \qquad ( 3 )$$

In addition, the similarity verifying unit 400 determines that the first and second records are not similar when a position at which a comparison token in the first record set, which is allocated to a word identical to a median value token disposed at a position corresponding to a median value in the second record set, is in a preset range.

Here, a method for determining similarity between two records includes a generating step for removing pairs, which are not similar among a plurality of records, to generate similarity determination candidate pairs, and a verifying step for verifying a determination target according to the threshold value after calculating an actual similarity of each similarity determination candidate pair. The similarity verifying unit 400 uses a median filter scheme in the verifying step.

FIG. 2 illustrates a token position and an index value according to an array of first and second record sets corresponding to similarity determination candidate pairs. An operation of the similarity verifying unit 400 will be described with reference to FIG. 2.

Firstly, the token indexes of the first record set have values of x[min_x:max_x], which is min_x or greater and max_x or smaller, and token indexes of the second record set have values of x[min_y:max_y], which is min_y or greater and max_y or smaller. For example, when the number of tokens, namely, the number of elements of the first record set is 15, the token indexes of the first record set have values of 0 to 14, and 15 tokens are stored at positions designated by the indexes to form an array.

Next, the similarity verifying unit 400 determines that the two record sets are not similar when an overlap similarity O of the first and second record sets is smaller than α. When a range of a position where a value of a token y[mid_y] at an index mid_y, which is a central position in the array of the second record set, may appear in the array of the first record set is x_low or greater and x_high or smaller, the following Equation (4) or (5) is to be satisfied in order for the first and second record sets not to be similar.

(max_{y}−mid_{y})+(x_{low}−minₓ)+O+1<α (4)

where a first term denotes the number of tokens of an upper part in the second record set, a second term denotes the number of tokens of a lower part in the first record set, a third term O denotes the number of current common tokens, and a fourth term denotes that 1 is added where 1 is a position value of a comparison token x[p_x] in the first record set, which has the same value as the median value token y[mid_y] disposed at a position corresponding to a median value in the second record set.

(mid_{y}−min_{y})+(maxₓ−x_{high})+O+1<α (5)

On the other hand, similar to Equation (4), Equation (5) means a condition that a pair would not be similar when the numbers of pluralities of tokens are symmetrically summed.

When Equations (4) and (5) are deployed to calculate ranges of x_low and x_high, in which two records are not similar, the following Equations (6) and (7) are derived.

x_{low}<α−O−max_{y}+mid_{y}+minₓ−1 (6)

x_{high}>O−α+mid_{y}−min_{y}+maxₓ+1 (7)

In other words, according to Equations (6) and (7), two records are not similar when a token in the first record set, which has the same value as the token y[mid_y] stored at a position designated by the index mid_y corresponding to a central position of the second record set, is disposed ahead of a token x[α−O−max_{y}+mid_{y}+minₓ−1] calculated with Equation (6) or behind a token x[O−α+mid_{y}−min_{y}+maxₓ+1] calculated with Equation (7).

When this is transformed into a condition for determining that the two records are similar on the basis of a token value, the following Equations (8) and (9) would be satisfied at the same time.

y[mid_{y}]≧x[α−O−max_{y}+mid_{y}+minₓ−1] (8)

y[mid_{y}]≦x[O−α+mid_{y}−min_{y}+maxₓ+1] (9)

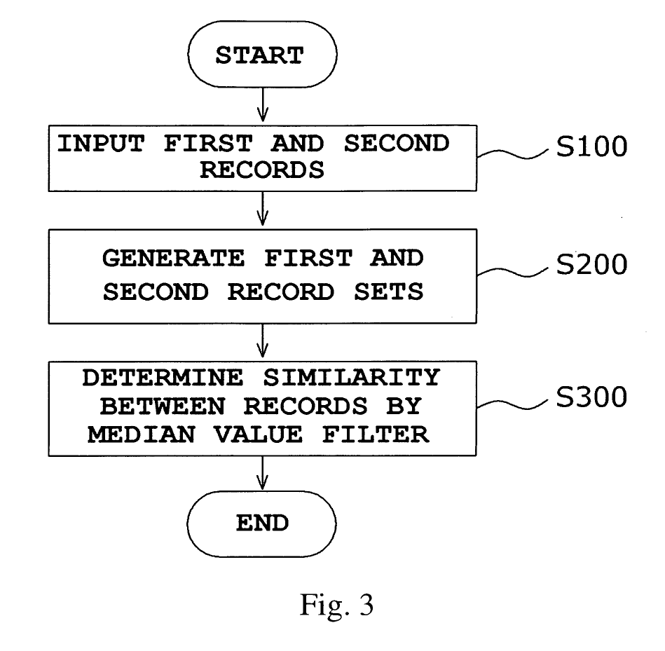

FIG. 3 is a view illustrating a data evaluation method using similarity according to an embodiment of the present invention.

Firstly, as input values, a first record x and a second record y are input (step S100).

Next, words in the first and second records are arrayed in alphabetical order and one token is given to each arrayed word to generate corresponding first and second record sets (step S200). In other words, the first record becomes x[0:|x|−1], which is a set of tokens having indexes of 0 or greater and smaller than |x|−1, and the second record becomes y[0:|y|−1], which is a set of tokens having indexes of 0 or greater and smaller than |y|−1. In addition, as the foregoing, blanks and punctuations may be used as distinguishing characters for arraying the words in alphabetical order and at the time of arraying the words, the ASCII order may be used.

Thereafter, it is determined that the first and second records are not similar when a position at which a comparison token in the first record set, which is allocated to a word identical to a median value token disposed at a position corresponding to a median value in the second record set, is in a preset range (step S300).

Here, the following table 1 shows an algorithm for realizing a data evaluation method using similarity according to an embodiment of the present invention, wherein Px denotes a variable for representing an index indicating a token position in the first record set and Py denotes a variable for representing an index indicating a token position in the second record set.

TABLE 1

VerifyM(x, y, O, α)

input : two records x[pₓ: |x|−1] and y[p_{y}: |y|−1], O and α

between the two records.

output: if the number of overlapped tokens between the

two records is not less than α, then store them as
a similarity join pair.

| | |
|---|---|
| 1 | r = α − O; // the number of tokens |

to be overlapped between the two records

| | |
|---|---|
| 2 | mid = (p_{y} + \|y\|−1) /2; // median position |
| 3 | v_{mid} = y[mid]; // the value of median position |
| 4 | if v_{mid} ≧ x[r − \|y\| + mid +pₓ] |

and v_{mid} ≦ x[|x| − r + mid − p_{y}] then

| | |
|---|---|
| 5 | while p_{y} < \|y\| and pₓ < \|x\| do |

| | |
|---|---|
| 6 | if x[pₓ] < y[p_{y}] then |

| | |
|---|---|
| 7 | pₓ + + ; |
| 8 | if \|x\| − pₓ < r then break; |

| | |
|---|---|
| 9 | else if x[pₓ] > y[p_{y}] then |

| | |
|---|---|
| 10 | p_{y} + + ; |
| 11 | if \|y\| − p_{y} < r then break; |

| | |
|---|---|
| 12 | else then // overlapped token |

| | |
|---|---|
| 13 | r − − ; pₓ + + ; p_{y} + + ; |

| | |
|---|---|
| 14 | enddo // end of line-5-while-loop |
| 15 | if r ≦ 0 then store the records x and y |

as a similarity join pair;

| | |
|---|---|
| 16 | endif // end of line-4-if-clause |

Here, the overlap similarity O may be calculated with Equation (2), and the overlap similarity O herein means the number of tokens to a currently input position, namely, tokens common to x[0:pₓ−1] and y[0:p_{y}−1].

Furthermore, the number α□ of tokens common to the two records in order for the two records to be similar may be calculated with Equation (3).

r calculated at step 1 of Table 1 means the minimum number of common tokens necessary for determining that the first and second records are similar between two record sets x[pₓ:|x|−1] and y[p_{y}:|y|−1]. In other words, in steps after step 1 in Table 1, when r or more common tokens are found, the first and second records are determined to be similar.

In addition, v_{mid} at step 3 of Table 1 denotes y[mid_{y}] of Equations (8) and (9), namely, a value of a token positioned at the center in the second record set, and is also represented as y[mid] in Table 1.

Furthermore, step 4 of Table 1 is to realize Equations (8) and (9), and for convenience, filtering is performed on the basis of a token value. However, as indicated in Equation (6) or (7), filtering may be performed by comparing index values, namely, token positions.

When the foregoing condition at step 4 is satisfied, two records are possibly similar and then steps thereafter are performed. Otherwise, two records are determined to be dissimilar.

In addition, at steps 5 to 14 of Table 1, according to a result of comparing tokens having indexes Pₓ and P_{y}, values of r, Pₓ, and P_{y} are increased or decreased.

Furthermore, at steps 8 to 11 in Table 1, when the number of tokens remaining in each record set is smaller than r, since the two records are not candidates to be similar any more, the routine breaks out of the while-loop.

In addition, at step 15 of Table 1, when r is equal to 0 or smaller, it means that the number of common tokens is α or greater and the first and second record are determined to be similar and stored.

The data evaluation method using similarity according to an embodiment of the present invention may be realized into a program and stored on a computer-readable recording medium (e.g. CD-ROM, RAM, ROM, floppy disk, hard disk, opto-magnetic disk, or the like).

In order to evaluate performances of the device and method of the present invention, an algorithm positional prefix join (PPJoin, generalizing prefix filtering-based algorithm), which is adopted as a reference for performance evaluation from among the existing algorithms, and an adaptive prefix join (APJoin, adaptive prefix filtering-based algorithm), which is a recently disclosed algorithm, are realized. Hereinafter, the algorithm PPJoin will be written as PP, and in the step for verifying a similarity join candidate pair, application of the algorithm of Table 1 including the median filter to the algorithm PPJoin will be written as PPMF. The algorithm APJoin will be written as AP and application of the algorithm of Table 1 to the algorithm APJoin will be written as APMF.

Table 2 represents the number of similarity join candidate pairs, each of which is obtained from four algorithms when a threshold value t of a Jaccard similarity varies with respect to an Enron data set (total 2,362,095 tokens and average 285 tokens), from second to fifth columns and represents the number of actual similarity join pairs at the last column.

TABLE 2

| t | \|C_{PP}\| | \|C_{PPMF}\| | \|C_{AP}\| | \|C_{APMF}\| | \|SJoin\| |
|---|---|---|---|---|---|
| 0.6 | 313,215,063 | 295,449,722 | 442,460,330 | 305,159,966 | 9,809,066 |
| 0.65 | 163,986,648 | 136,029,026, | 221,105,699 | 140,814,632 | 8,894,058 |
| 0.7 | 79,838,350 | 58,372,375 | 104,030,136 | 60,703,266 | 6,061,086 |
| 0.75 | 35,734,847 | 22,964,234 | 45,196,031 | 23,992,140 | 3,477,781 |
| 0.8 | 15,110,283 | 9,073,627 | 18,365,578 | 9,480,527 | 2,729,318 |
| 0.85 | 6,287,360 | 4,055,639 | 7,233,319 | 4,184,646 | 2,113,168 |
| 0.9 | 3,108,266 | 2,467,064 | 3,292,171 | 2,505,509 | 1,437,101 |
| 0.95 | 1,393,473 | 1,273,183 | 1,409,082 | 1,277,615 | 1,076,620 |
| 1.0 | 951,019 | 928,509 | 951,019 | 928,509 | 895,144 |

Here, |C_{PPMF}| and |C_{APMF}| of Table 2 are the respective numbers of similar candidates after the method of the present invention is applied, and compared to |C_{PP}| and |C_{AP}| according to typical methods, it may be seen that there are a great decrease in number. In other words, when the threshold value is 0.8, |C_{PPMF}| is decreased in number by about 40% in comparison with |C_{PP}|, and at the same threshold value, |C_{APMF}| is decreased in number by about 48% in comparison with |C_{AP}|.

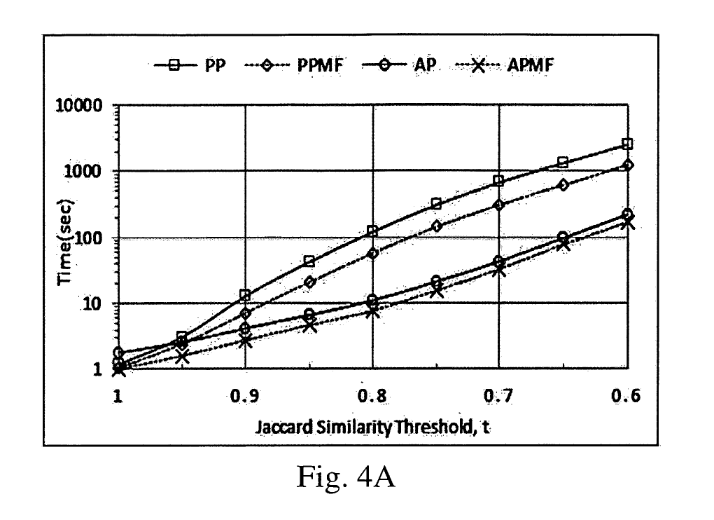

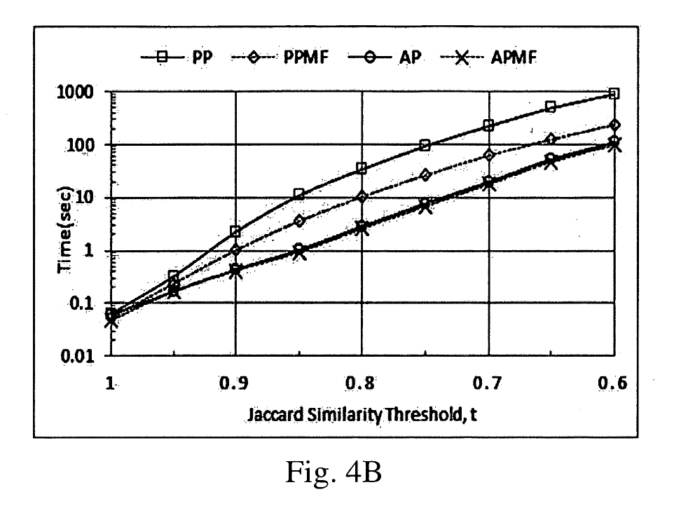

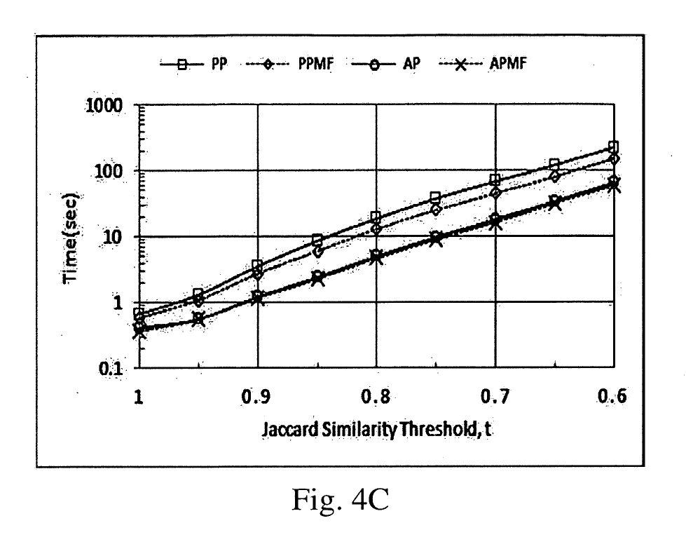

FIG. 4A is a graph representing, according to a threshold value t, execution times during which four algorithms are executed with respect to records obtained by collecting emails of Eron company, FIG. 4B is a graph representing, according to a threshold value t, an execution time during which four algorithms are executed with respect to bench macro documents included in a Trec data set (total 1,776,061 tokens and average 158 tokens per document), and FIG. 4C is a graph representing, according to a threshold value t, an execution time during which four algorithms are executed with respect to a reference list record (total 1,293,322 tokens and average 21 tokens per document), which is obtainable from a DBLP web site.

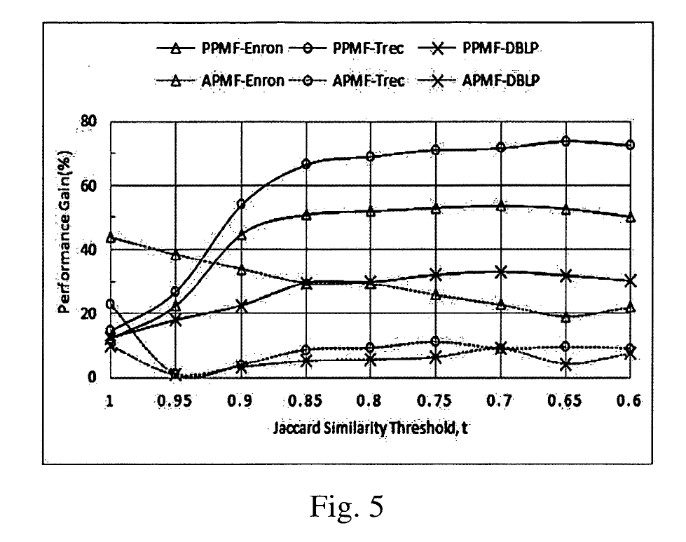

FIG. 5 is a graph illustrating a relative performance gain obtained by applying a data evaluation method using similarity to three data sets used in FIGS. 4A to 4C.

Here, a performance gain of PPMF-Enron may be calculated as the following Equation (10).

$$Performance {gain}_{PPMF \text{-} Enron} = 100 \times \frac{{T}_{PP \text{-} Eron} - {T}_{PPMF \text{-} Enron}}{{T}_{PP \text{-} Enron}} \% \qquad ( 10 )$$

where T_{PPMFF-Eron} and T_{PP-Eron} respectively denote execution times of a method PPMF of the present invention and a method of the algorithm PP for the Enron data set.

According to FIGS. 4A and 5, the performance gain according to the method of the present invention is about 52% of that of PPMF and about 29% of that of APMF. In other words, referring to FIGS. 4A to 4C and 5, the PPMF, in particular, according to the methods of the present invention shows high improvement in performance between about 20% to about 70%.

In other words, according to the method of the present invention, similarity candidate pairs may be rapidly determined from among data sets in which the average number of records is very large.

For similar record candidate pairs, a similarity determination result may be rapidly obtained by using a median value of token indexes allocated to words in one record as a filter for checking whether the number of tokens common to other records is proper.

In addition, a filtering cost may be offset and performance may be improved by applying a simple filter to a step for verifying similar record candidates.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A data evaluation device using similarity comprising:
an input unit receiving first and second records;
a record set generating unit arraying words in the first and second records in alphabetical order and giving one token to each arrayed word to generate corresponding first and second record sets; and
a similarity verifying unit determining that the first and second records are not similar when a position at which a comparison token in the first record set, which is allocated to a word identical to a median value token disposed at a position corresponding to a median value in the second record set, is in a preset range.

2. The data evaluation device using similarity of claim 1, wherein the alphabetical order is ASCII code order.

3. The data evaluation device using similarity of claim 1, further comprising a similarity calculating unit calculating a similarity of the first and second records as a Jaccard similarity defined as
$$\frac{\vert first record set ⋂ second record set \vert}{\vert first record set ⋃ second record set \vert}$$
and an overlap similarity defined as |first record set∩second record set|.

4. The data evaluation device using similarity of claim 3, wherein a Jaccard minimum value, which is a minimum value for determining the first and second records to be similar according to the Jaccard similarity has a relation of
$$overlap min value = \frac{Jaccard min value}{Jaccard min value + 1} \times ( \vert first record set \vert + \vert second record set \vert )$$
with an overlap minimum value, which is a minimum value for determining the first and second records to be similar according to the overlap similarity.

5. The data evaluation device using similarity of claim 4, wherein the similarity verifying unit sequentially allocates indexes to tokens in the first record set and tokens in the second record set, and determines that the first and second records are not similar when an index of the comparison token is smaller than
overlap min value−|first record set∩second record set|−max index of second record set+index of median value token+min index of first record set−1.

6. The data evaluation device using similarity of claim 4, wherein the similarity verifying unit sequentially allocates indexes to tokens in the first record set and tokens in the second record set, and determines that the first and second records are not similar when an index of the comparison token exceeds

|first record set∩second record set|−overlap min value+index of median value token−min index of second record set+max index of first record set+1.
